(19) United States
(12) Patent Application Publication
(10) Pub. No.: US 2010/0175327 A1
(43) Pub. Date: Jul. 15, 2010

(54) Driver Device for a Sliding Door

(76) Inventors: Sven Busch, Dortmund (DE); Thomas Schüler, Wetter (DE)

Correspondence Address: COHEN, PONTANI, LIEBERMAN & PAVANE LLP, 551 FIFTH AVENUE, SUITE 1210, NEW YORK, NY, 10176, US

(21) Appl. No.: 12/668,570

(22) PCT Filed: Jul. 8, 2008
(86) PCT No.: PCT/EP08/05550

§ 371 Date: Jan. 11, 2010

(30) Foreign Application Priority Data
Jul. 10, 2007 (DE) 10 2007 032 476.8

(51) Int. Cl. E05D 15/06; E05F 11/54

(52) U.S. Cl. 49/360; 49/404

(57) ABSTRACT

A driver device for a panel to be moved along a travel path is disclosed. The driver device has a driver member, which is adapted to be stationarily mounted to a member guided along the travel path. Furthermore, the driver device has a spring element, which is mounted to the guided member and is propped up at a side of the panel to be moved facing the guided member. At least with regard to a direction of the pre-tensioning of the spring element, the driver member is loosely coupled to the panel to be moved. The spring element is pre-tensioned such as to press the guided member and the driver member away from each other.

The invention relates to a driver device for a sliding door, in particular an automatic sliding door.

Sliding doors are very well known. Sliding door leaves are coupled to a traction rope of a rope drive mostly by means of a rigid driver. The rigid driver transfers all movements of a coupled sliding door leaf, almost undamped, onto the traction rope, which may lead to excessive loads of the tensioned traction rope. In case of a drive motor, which is operatively connected to the traction rope, under certain circumstances higher loads with regard to the driving force of the drive motor may be the result.

In a sliding door driven by means of a spindle drive, such rigid drivers are disadvantageous, because unwanted movements of a respective sliding door leaf are transferred onto a threaded spindle of the spindle drive. Therefore, such a threaded spindle, as a rigid member, may be exposed to excessive loads, and may be damaged through bending, for example, which may interfere with the automatic operation of the sliding door or may even result in failure of the drive.

Similar risks are given in a sliding door which is driven by a linear motor. In this case, rigid drivers are likewise disadvantageous. A rotor needs to have a distance to the stator of the linear motor, which distance lies in a relatively small tolerance range. Furthermore, the distance between rotor and stator is relatively small. If the sliding door leaf moves away from the stator, for example due to an uneven guiding rail, the rotor is entrained and moved away from the stator. This circumstance may lead to the fact that the distance between rotor and stator becomes too large for a smooth operation of the linear motor.

Therefore, the object of the invention is to at least reduce the above mentioned disadvantages.

This problem is solved with a driver device according to claim 1. Advantageous further developments are set forth in the dependent claims.

An inventive driver device for a panel to be moved along a travel path has a driver member, which is adapted to be mounted stationarily to a driving part of a linear motor. Furthermore, the driver device has a spring element, which is mounted to the driving part and is propped up at a side of the panel to be moved, which faces the driving part and is pre-tensioned to a certain degree. In addition, the driver member, at least with regard to a direction of the pre-tensioning, is loosely coupled to the panel to be moved. This means, the driver member is not coupled to the panel to be moved, therefore not rigidly connected. The spring element is pre-tensioned to a certain degree such that the driving part and the driver member are pressed away from each other. It is thereby possible to compensate for unevenness along the travel path of the panel to be moved or at least to dampen it, without having to greatly modify the overall structure.

With an end facing the panel to be moved, the driver member engages in a reception portion of the panel to be moved. In this case, a penetration depth of the driver member is smaller than a depth of the reception portion of the panel to be moved. It is thereby insured that the panel to be moved can move towards the driver member up to a predetermined measure, without having any effect on the driver member and thus on the linear drive.

The driver member, at an end facing away from the panel to be moved, is disposed and configured to be pivotable at least about an axis transverse with regard to a direction of movement of the panel to be moved and transverse with regard to a direction towards the panel to be moved. This is advantageous in that even jerky movements of the panel to be moved can be compensated for or can at least be damped in the travel direction.

Preferably the driver member has an insertion portion. In contrast thereto, the panel to be moved has a mounting portion with a reception. The insertion portion is formed such that, upon insertion into the reception, it is clamped in or it latches with the reception. Thereby, a particularly simple installation is provided. Screws or other attachment means are not required.

The insertion portion has latching projections, which preferably extend parallel to each other and have a predetermined distance to each other. The above described reception of the mounting portion has a slot-shaped opening at least in an area which is nearest to the driver member. This opening has an opening width, which is at least slightly smaller than a distance of exterior ends of the latching projections to each other, the slot-shaped opening extending parallel to a longitudinal extension of a respective latching edge of one of the latching projections. Such a latching connection provides a particular simple installation, the driver member with the latching projections is put into the reception and the projections automatically latch with the reception.

Preferably the spring element is configured as a hinge spring. With one end, the hinge spring is propped up at a side of the driving part facing the panel to be moved or is stationarily mounted thereto. With the other end, it is propped up at a side of the panel to be moved, which faces the driving part. Thereby, the hinge spring is fixed in place at one end in its relative position with regard to the driver member. If the panel to be moved presses on the hinge spring, the latter is able to be compressed in that the other end, propped up at the panel to be moved, can move away from the one end of the hinge spring.

As an alternative, the spring element can be configured as a helical spring. According to the invention, with one end, the helical spring is propped up at a side of the driving part facing the panel to be moved and, with another end, it is propped up at a side of the panel to be moved, which faces the driving part.

The spring element and the driver member are preferably configured integrally. In this case, the spring element forms a spring portion and the driver member forms a driver portion of the inventive driver device. The integral configuration simplifies the installation, only a single piece is to be installed.

In this case the driver portion, according to the invention, preferably has a reception, which, in an inserted condition, is configured such as to reach a latching engagement or clamping engagement with a complementarily configured counter-piece in the area of the reception, which piece is conformed or disposed at the driving part. This means the driver device is simply clipped into the counter-piece or latched with the latter, which represents a very simply installation.

Further features and advantages of the invention will become apparent from the following description of preferred embodiments, in which:

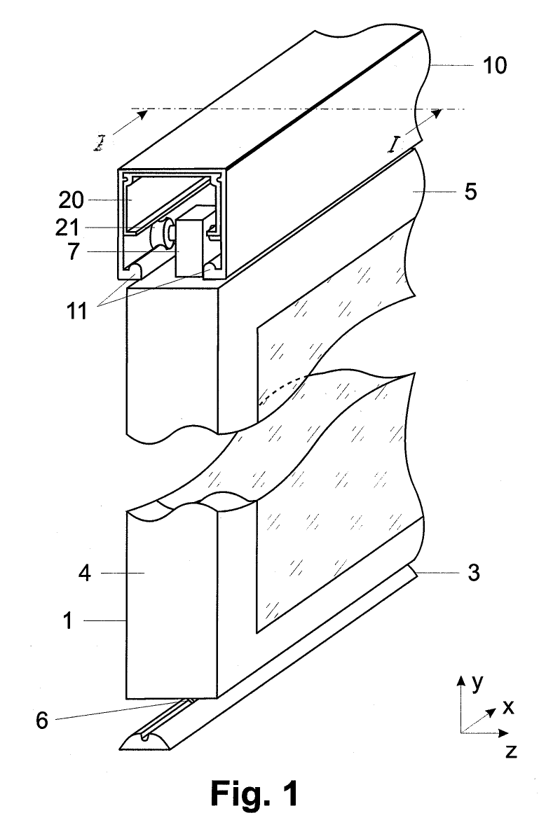

FIG. 1: shows a sliding door suspension,

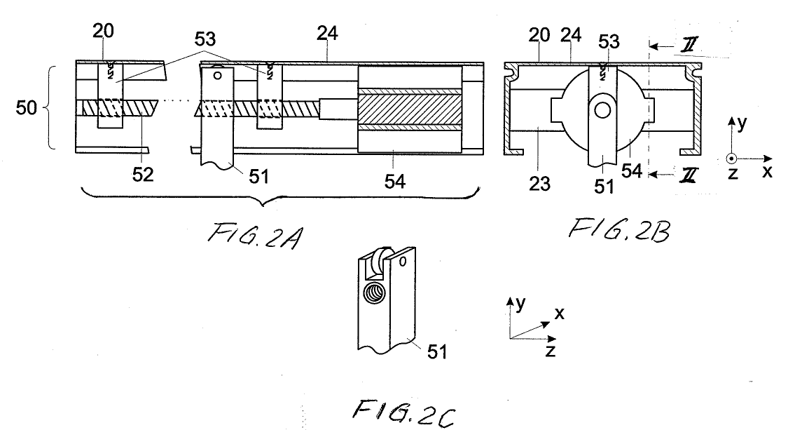

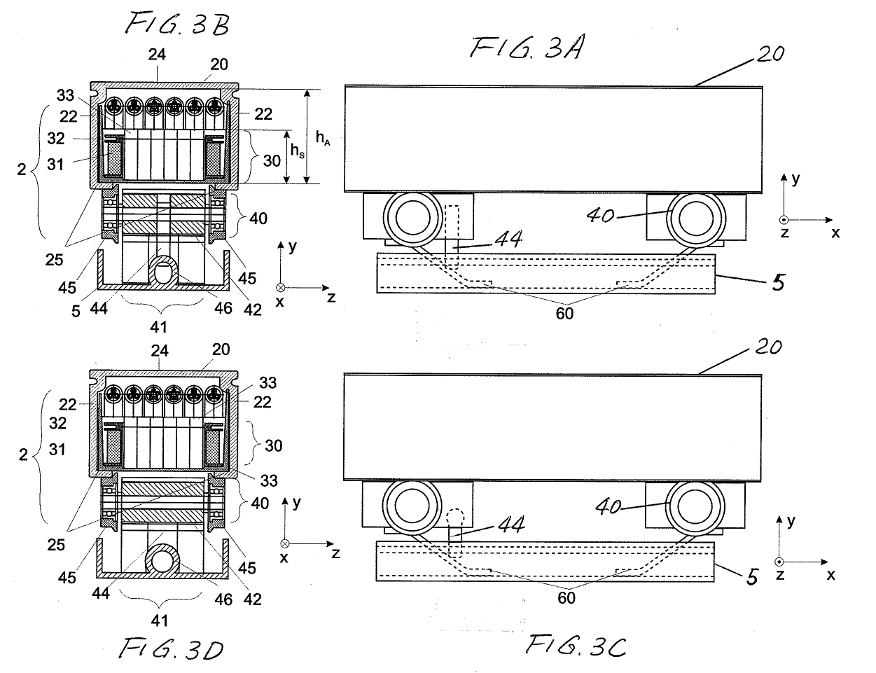

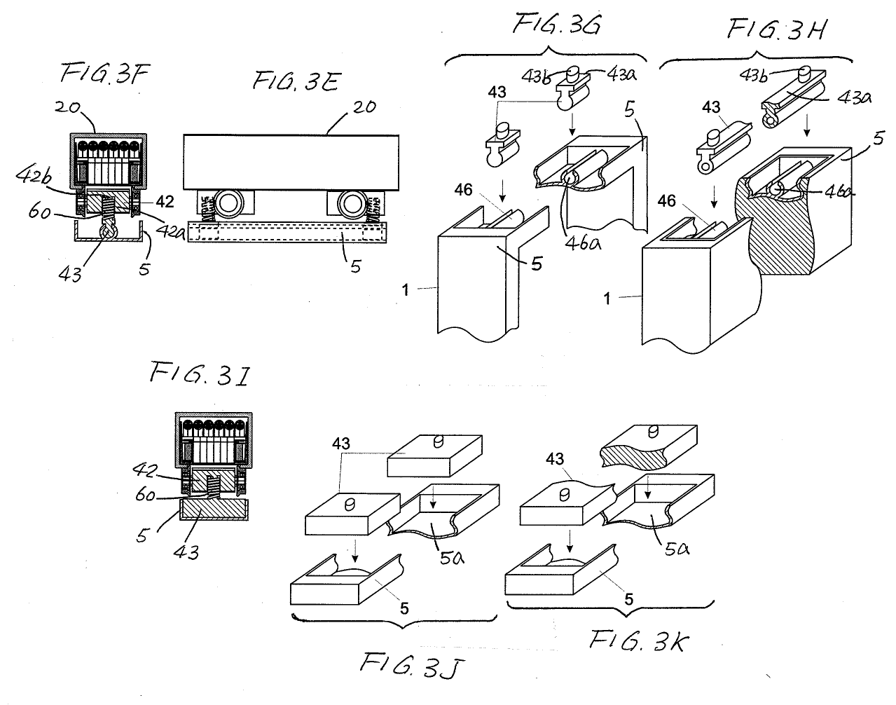

FIG. 2: shows a driver device utilized in a spindle drive for the sliding door suspension of FIG. 1,

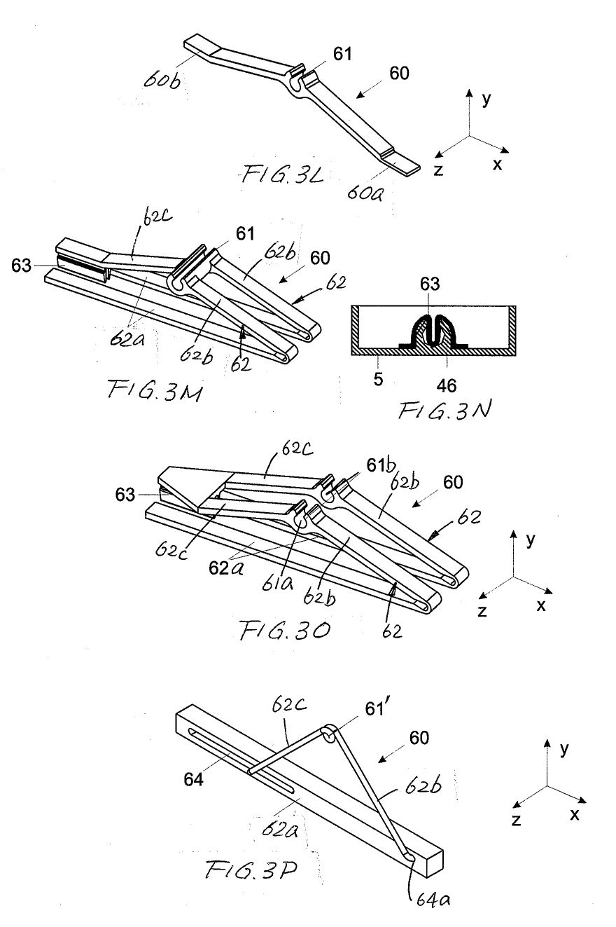

FIG. 3: shows driver devices, according to different embodiments of the invention, utilized in a linear motor drive for the sliding door suspension of FIG. 1, and

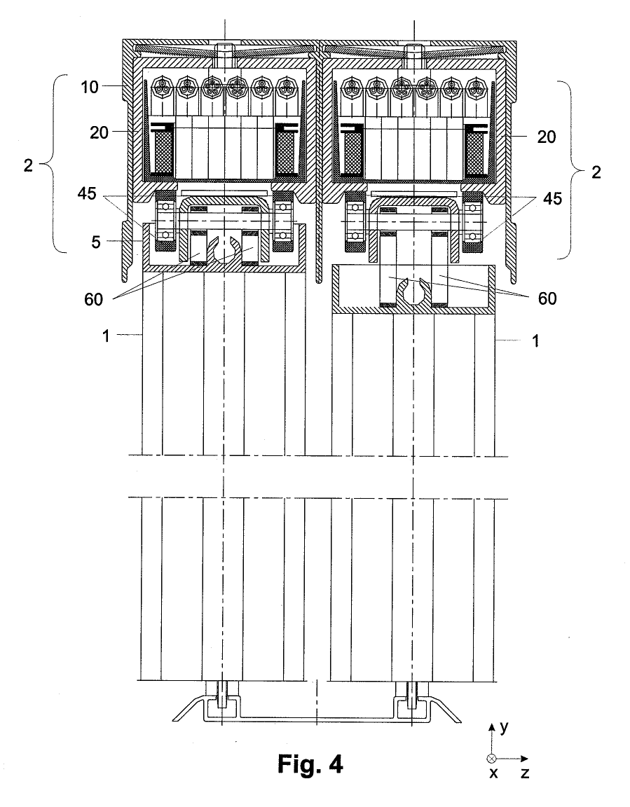

FIG. 4: shows driver devices, according to different embodiments of the invention, utilized in a multi-leaf sliding door suspension.

As shown in FIG. 1, a suspension has a sliding door leaf 1, which is guided and supported in a guiding profile 10. In the example illustrated in FIG. 1, the sliding door leaf 1 is formed by means of a glass pane surrounded by a frame 4. The frame 4 has an upper frame part 5, which may be configured integrally with the rest of the frame 4. At a lower border, the sliding door leaf 1 is guided in a floor rail 3 by means of rollers 6, preventing the sliding door leaf 1 from breaking away in the ±z-coordinate direction in FIG. 1. In addition, the roller 6 may be provided to absorb the weight of the sliding door leaf 1 such that upper guiding rollers 21, provided in the guiding profile 10, are relieved.

As an alternative, the lower rollers 6 are omitted such that the sliding door leaf 1 is received in the guiding profile 10 in a freely floating manner.

At a top side, i.e., at a side facing the guiding profile 10, when seen in the y-coordinate direction, the upper frame part 5 has respectively one roller mounting 7 preferably at both ends, FIG. 1 revealing only the roller mounting 7 facing the viewer. At each roller mounting 7, parallel to an x-z-plane, when seen in the x-coordinate direction, on the right and left hand sides, respectively one guiding roller 21 is disposed freely rotatably with regard to the respective roller mounting 7. The guiding rollers 21 each run on an associated guiding rail 11 of the guiding profile 10.

In the example illustrated in FIG. 1, the guiding rails 11 have a crown-shaped running surface. The guiding rollers 21 have a running surface configured complementarily to the running rail. This type of running surfaces prevents the guiding rollers 21 from breaking away in ±z-coordinate direction.

Above the guiding rollers 21, a driving profile 20 is fitted or inserted into the guiding profile 10. The driving profile 20 is intended to receive or to support parts of a linear drive system, which is not visible in FIG. 1.

In a section, FIG. 2 shows a driver device utilized in a spindle drive 50. On the right hand side in FIG. 2, a sectional view along the line A-A in FIG. 1 is illustrated. On the left hand side, a sectional view along a line E-E is illustrated.

A drive motor 54 is accommodated in a driving profile 20, respectively in a motor mounting 23. An output shaft of the drive motor 54 is operatively coupled to a threaded spindle 52. The threaded spindle 52 is freely rotatably supported in a spindle bearing 53. According to FIG. 2A, the spindle bearing 53 has two bearing parts, which are mounted at an interior side of the upper wall section 24, and extend in the direction of the threaded spindle 52, i.e., in −y-coordinate direction in FIG. 2. The bearing parts each have one through-opening for the reception of the threaded spindle 52. The through-openings may have a smooth interior surface.

As an alternative, the through-openings are provided with a female thread into which the threaded spindle 52 is screwed. As an alternative, a bearing bushing is fitted into the through-opening, which bushing has a female thread on the inside into which the threaded spindle 52 is screwed. It is thereby possible to manufacture the respective bearing part from an inexpensive material and to produce only the bearing bushing from a material, which is suitable for bearing the threaded spindle 52. Preferably, the bearing bushing is freely rotatably disposed within the through-opening. As shown in FIG. 2A, the bearing parts can be attached at the horizontal wall section 24, for example by means of screws, or they can be integrally formed with the driving profile 20.

A driver 51 according to a first embodiment of the invention likewise has a through-opening for the reception of the threaded spindle 52 and has a female thread on the inside, into which the threaded spindle 52 is screwed. The driver 51 may have an above described bearing bushing with the restriction that the bearing bushing is disposed torque-proof with regard to the driver 51. In addition, at an end facing away from the sliding door leaf 1, the driver has a roller, the axis of rotation thereof extending in the ±z-coordinate direction in FIG. 2B. The roller is freely rotatably disposed in the driver such that it rolls on an interior surface of the upper wall section 24. This circumstance serves to prevent the threaded spindle 52 from bending in y-coordinate direction in FIG. 2B, in the area of the driver 51. The roller may as well be replaced by a sliding block respectively by a sliding surface.

In FIG. 3A, a linear motor drive is shown, which is incorporated into the sliding door suspension of FIG. 1. A linear motor 2 has a stator 30 and a rotor 40. The stator 30 is formed by means of at least one stator module. When seen in ±x-coordinate direction in FIG. 3B, each stator module has a row of consecutively disposed coils 31, which are wired according to a predetermined control scheme. The coils 31 are preferably fitted onto, respectively mounted on associated coil forms 32. The coil forms 32 are preferably mounted onto a magnetizable keeper 33 and are preferably moulded with the latter to form a stator module.

The one stator module is or more stator modules are preferably inserted respectively into a reception profile, which is adapted to be inserted into the above described driving profile 20. This means, instead of the above described linear drives as complete modules, in this case, just the stator 30, as a component of the linear motor 2, is inserted into the driving profile 20. The reception profile is preferably formed such that, during insertion into the driving profile 20, it gets locked in order to be reliably retained. As an alternative, latching connections, screw connections or all other attachment options are possible.

As an alternative, each stator module is directly inserted into the driving profile 20.

Preferably, the stator modules have a height h_{S}, which is inferior to a height h_{A} of a reception space of the driving profile 20 for the stator 30. This means that a hollow space is provided above the stator. This hollow space is useful for example if, when seen in ±z-coordinate direction in FIG. 3A, stator modules of the stator 30 have a distance with regard to each other and if additional components, such as a smoke detector, are to be accommodated in an intermediate space thus provided between the stator modules. Another application case is a multi-leaf sliding door. In this case, several stators 30 are accommodated in the driving profile 20, which for example need to be differently controlled with regard to their drive direction. This implies that the stators 30 require at least separate control lines. By means of the above described hollow space, it is possible to have all lines of all the stators 30, respectively stator modules, and if required of additional components, exit the guiding profile 10 at a single location. It is thereby possible to provide a single port at a single location of the sliding door suspension. One cable duct can be used for all required lines, thus resulting in a considerably simplified cabling.

The ends of the sidewall sections 22, facing away from the horizontal wall section 24, are adjoined by projections 25, which are configured parallel to the horizontal wall section 24 and are facing each other. Upper surfaces of the projections 25 form bearing surfaces for the stator 30. The stator 30 is thus resting with an underside on these projections 25.

The rotor 40 associated to the linear motor 2 is formed by means of one or more rotor parts 41, which, when seen in the ±z-coordinate direction in FIG. 3A, is or are disposed between roller mountings 7 of a respective sliding door leaf 1. This means that each rotor 40 is disposed in an intermediate space respectively formed between two roller mountings 7.

In order to prevent the rotor 40 from sticking to the stator 30, the rotor members 41 are provided with rotor rollers 45. Advantageously, the rotor rollers 45 are disposed such as to roll respectively on an underside of the above described projections 25 of the driving profile 20. Thus, the projections 25 have several functions. On the one side, they serve to support the stator 30 on the top and the rotor 40 to the bottom. On the other side, in conjunction with the rotor rollers 45, they guarantee a predetermined minimum distance between stator 30 and rotor 40. Thereby, in terms of an interaction between the stator 30 and the rotor 40, a desired operation of the linear motor 2 is made possible. Furthermore, the rotor 40 is guided along the projections 25 and thus along a travel path to be respected. For this purpose, the rotor rollers 45 each have preferably at least one wheel flange.

Between the rotor 40 and the sliding door leaf 1, preferably a driver device is provided according to another embodiment of the invention shown in FIG. 3A. A connecting pin 44 is stationarily mounted preferably in a body 42 of the rotor 40 or is inserted into the latter by means of screwing. The connecting pin 44 protrudes from the body 42 into the direction of the sliding door leaf 1 to an extent that its free end is disposed below an upper end portion of a mounting portion 46 of the sliding door leaf 1, which mounting portion 46 serves to receive the connecting pin 44. The mounting portion 46 has a reception, into which the connecting pin 44 engages and thus entrains the sliding door leaf 1 during a movement of the rotor 40. In addition, the reception has a depth, which is deeper than a maximum possible penetration depth of the connecting pin 44 into the reception. Thereby the sliding door leaf 1 can move up to a predetermined measure in the ±y-coordinate direction, without having a particular effect on the connecting pin 44.

In contact surfaces with the connecting pin 44, the reception is preferably coated with an elastic plastic material or is formed by means of this plastic material. Thereby, despite a constant contact between the connecting pin 44 and the reception, a certain play is possible between them without resulting in delays in the movements of the rotor 40 and the sliding door leaf 1, and therefore without resulting in a jerky or irregular movement of the sliding door leaf 1.

Preferably, the reception is configured such that the sliding door leaf 1 can move to a predetermined extent in the ±z-coordinate direction with regard to the connecting pin. For this purpose, when seen in the ±y-coordinate direction in FIG. 3A, the reception has an oblong hole-shaped cross-section extending preferably in the ±z-coordinate direction. A transmission of transverse movements of an upper portion of the sliding door leaf 1, i.e., movements in the ±y-coordinate direction in FIG. 3A, is at least weakened to a predetermined extent.

As an example, in FIG. 3A an upper frame part 5 of the sliding door leaf 1, not illustrated in detail, is shown, namely once in a section and once in a frontal view. When seen in the direction of its longitudinal extension, the upper frame part 5 has a mounting portion 46 in the center, which in cross-section preferably has the shape of an O. At two locations respectively one spring element 60 is attached with one end to in this case the body 42. The spring elements 60 also extend in the direction of the sliding door leaf 1 and are propped up at an upper surface of the upper frame part 5.

Preferably already in a resting state of the sliding door leaf 1, the spring elements 60 are pre-tensioned. Thus on account of the spring elements 60, the rotor 40 is pressed in the direction of the stator 30. In conjunction with the rotor rollers 45 it is thus guaranteed that the rotor 40 has an almost constant distance to the stator 30, which is required for the operation of the linear motor 2. Furthermore, the spring elements 60 achieve that possible unevenness in the travel path of the sliding door leaf 1 and/or other movements of the sliding door leaf 1, as a desired, so to say “ideal” travel motion, are not transferred onto the rotor 40, at least not to a considerable extent. Despite the fact that the sliding door leaf 1 is entrained by the rotor 40, the furthest possible uncoupling of rotor 40 and sliding door leaf 1 is realized with regard to unwanted movements of the sliding door leaf 1. In addition, an attraction force is possible between the rotor 40 and the stator 30, which is smaller than the weight force of the rotor 40.

As an alternative or in addition thereto, it is intended to pivotably support the connecting pin 44 in the body 42 to a predetermined extent, at least about an ±x-coordinate axis in FIG. 3A. Thereby, a simple possibility is created to prevent completely or to a high degree the transmission of at least unwanted transverse movements of the sliding door leaf 1 onto the rotor 40. If the connecting pin 44, as shown in FIG. 3C, is additionally supported pivotably about the ±z-coordinate axis, jerky movements of the sliding door leaf 1 in the ±x-coordinate direction are at least dampened. Furthermore, during the state of acceleration, the rotor 40 entrains the sliding door leaf 1 only after a maximum possible pivoting of the connecting pin 44. During deceleration, the rotor 40 is already slowed down, prior to slowing down the sliding door leaf 1.

The mounting portion 46 is preferably manufactured from an elastic material. The spring elements 44 abut the mounting portion 46 laterally such that they clamp the mounting portion 46 to a predetermined extent and are thus able to relieve the connecting pin 44.

According to an embodiment of the invention shown in FIG. 3B, preferably at the end received in the body 42, the connecting pin 44 has the shape of a sphere, the exterior diameter thereof, seen parallel to the x-z-plane, being larger than the dimensions of at least a portion of the connecting pin 44, which portion is likewise received in the body 42. This allows for pivoting the connecting pin 44 in any direction of the x-z-plane.

In the linear drives, based on a traction means, usually rigidly formed drivers are intended for operatively connecting the traction means to the respective sliding door leaf 1.

FIG. 3C shows a driver device between the rotor 40 and the sliding door leaf 1, according to another embodiment of the invention. Helical springs are used as the spring elements 60 instead of leaf springs or hinge springs. The body 42 has receptions for the helical springs, which receptions are open at the bottom. Preferably one pin-shaped projection, extending in the direction of the sliding door leaf 1, is located within each reception. A respective helical spring is fitted into the reception and, at an end facing the body 42, onto a respective projection. At the other end, the helical spring is fitted onto a connecting element 43, shown in the right top of FIG. 3C. The connecting element 43 is configured such as to be inserted into the respective mounting portion 46, preferably by means of a clamping effect. For this purpose, the mounting portion 46 is configured to be open towards the rotor 40 and to have a reception, which expands to the bottom. The connecting element 43 has an exterior contour which is essentially complementary to an interior contour of the reception, the exterior dimensions thereof being preferably slightly larger than the corresponding interior dimensions of the reception. During insertion, the mounting portion 46 is spread open and the connecting element 43 is pressed into the reception. At the end facing the helical spring, the connecting element 43 has a spring abutment, against which the helical spring bears with its end facing away from the body 42. In addition, the connecting element 43 has a pin-shaped projection analogously to the projection in the reception in the body 42.

A separate connecting element 43 may be provided for each helical spring, as shown in the centre of FIG. 3C. As an alternative, all connecting elements 43 are configured as one piece, as shown on the right hand side in FIG. 3H. If the thus formed entire connecting element 43 has a length equivalent to a length of a reception space for the connecting element 43, the clamping force of the entire connecting element 43 may be smaller than in the previously described variant. Thus, at both ends, the connecting element 43 abuts at stop faces of the upper frame member 44, respectively of a recess, in the case of a solid leaf sliding door leaf 1 and thus reliably entrains the sliding door leaf 1.

In both variants, the spring element 60 additionally assumes a driver function with regard to the sliding door leaf 1.

If no mounting portion 46 is provided, according to a third embodiment of the invention shown in FIG. 3D, it is intended to use in turn the reception space itself of the upper frame profile 5, respectively of the solid leaf sliding door leaf 1. The difference to previous embodiments of the invention is that the one or more spring elements 60 are formed such that in their area, at least seen in ±z-coordinate direction, they completely fill the reception space. In case of several spring elements 60, at least one of them has dimensions which allow for clamping in the reception space.

In FIG. 3E, a spring element 60 is shown according to another embodiment of the invention. In a central section, this spring element 60 has a reception 61 for a rotating axle. The respective rotating axle is disposed in a respective body 42 of a rotor 40 of a linear motor 2 and extends in ±z-coordinate direction. The axle reception 61 allows for being simply fitted onto a non-illustrated axle-shaped part in the body 42 of a rotor 40 of a linear motor 2. During this fitting process, the axle reception reaches engagement with the respective axle-shaped part and prevents the spring element 60 from falling off the axle-shaped part.

Furthermore, the spring element 60 is made from an elastically deformable material. Analogously to the above described embodiments, free ends of the spring element 60 are propped up at an upper surface of a sliding door leaf 1 or of an upper frame part 5. Preferably, one end is configured to be flatter than the respective other one and is fitted into a reception configured at the upper surface of the sliding door leaf 1 or of the frame part 5.

An alternative spring element 60, according to yet another embodiment of the invention shown in FIG. 3F, has two legs having a seating portion 62, on which the spring element 60 is supported. In the same direction, respectively one spring portion, which is formed by means of a bent leg portion, adjoins each seating portion 62. These leg portions lead to a common axle reception. A side of the axle reception 61, facing away from the leg portions, is adjoined by an insertion portion 63, which is formed such as to be inserted into an above described mounting portion 46 by means of latching and preferably is arrested therein by means of clamping.

An alternative spring element 60, according to yet another embodiment of the invention shown in FIG. 3F, has two legs having a seating portion 62, on the underside thereof the spring element 60 being propped up. In the same direction, respectively one spring portion, which is formed by means of a bent leg portion, adjoins each seating portion 62. These leg portions lead to a common axle reception. A side of the axle reception facing away from the leg portions, is adjoined by another single leg portion, at the end thereof, facing away from axle reception 61, an insertion portion 63 is configured. The insertion portion 63 is formed such as to be inserted into an above described mounting portion 46 by means of latching and to be arrested therein preferably by means of clamping.

According to an embodiment of the invention shown in FIG. 3G, a spring element 60 is distinguished from the preceding embodiment in that the leg portions do not lead to an axle reception 61. Instead they have respectively their own axle reception 61. When seen in ±z-coordinate direction, the axle receptions 61, 61 are disposed to be aligned. The respective axle reception is adjoined by respectively another leg portion. These other leg portions lead to the above described insertion portion 63.

Yet another embodiment of the spring element 60 is shown in FIG. 3H. The seating portion 62 is formed by means of an essentially block-shaped part. An opening is formed in the seating portion 62 for an irrotational reception of one end of a hinge spring. The other end of the hinge spring is received in a guided manner in an oblong hole 64, which is configured in the block-shaped part and essentially extends in the direction of its longitudinal extension. In its center, the hinge spring preferably forms a through-opening, again for the reception of a rotating axle. As an alternative, the hinge spring, with this portion, is supported at the body 42 of a respective rotor 40.

FIG. 4 shows a multi-leaf sliding door suspension. The sliding door leaf 1, illustrated on the right side, has a lower height than the one illustrated on the left side. In order to compensate for the resulting height difference, the spring element 60 of the left driver device in the left sliding door leaf 1 has a smaller height than the right one. At the same time, a dimension of respective exterior ends of two opposite disposed rotor rollers 45, seen in ±x-coordinate direction in FIG. 4, is smaller than a width of the reception space of the upper frame part 5. Thereby it is possible to partially receive the rotor rollers 45 in the reception space of the upper frame part 5. This means that despite the different sliding door leaves, respectively the same linear drive, in this case in the shape of linear motors 2, can be used with a driver device for both sliding door leaves. Dimensions or positions of the members of the respective linear motor 2 with regard to each other or with regard to the respective driving profile 20 or guiding profile 10 remain the same.

Even if the invention has been primarily described in conjunction with a linear motor as a linear drive, it is readily applicable to all other linear drives and to manually suspended sliding doors as well.

In addition, the driver devices are exchangeable with each other or can be combined.

### LIST OF REFERENCE NUMERALS

1 sliding door leaf
2 linear motor
3 floor rail
4 frame
5 upper frame part
6 roller
7 roller mounting
10 guiding profile
11 guiding rail
20 driving profile
21 guiding roller
22 sidewall section
23 motor mounting
24 upper wall section
25 projection
30 stator
31 coil
32 coil form
33 keeper
40 rotor
41 rotor member
42 body
43 connecting element
44 connecting pin
45 rotor roller
46 mounting portion
50 spindle drive
51 driver
52 threaded spindle
53 spindle bearing
54 drive motor
60 spring element
61 axle reception
62 seating portion
63 insertion portion
64 oblong hole
h_{S} height of a stator module
h_{A} height of a drive profile reception space

1.-10. (canceled)

11. A driver device for a panel to be moved along a travel path, the driver device comprising:
a driver member adapted to be stationarily mounted at a guided member guided along the travel path, and
a spring element mounted to the guided member, the spring element being supported at a side of the panel to be moved facing the guided member,
wherein the driver member, at least with regard to a pre-tensioning direction of the spring element, is loosely coupled to the panel to be moved,
wherein the spring element is under a predetermined pre-tension while forcing the guided member and the driver member away from each other, and
wherein the driver member, with an end facing the panel to be moved, engages in a reception portion of the panel to be moved, a penetrating depth of the driver member being smaller than a depth of the reception portion in a penetration direction of the driver member into the reception portion of the panel to be moved.

12. The driver device according to claim 11, wherein the driver member, at an end facing away from the panel to be moved, is configured and disposed to be pivotable at least about an axis transverse to a direction of movement of the panel to be moved and transverse to a direction towards the panel to be moved.

13. The driver device according to claim 11, wherein the driver member has an insertion portion and the panel to be moved has a mounting portion with the reception portion, the insertion portion being formed to be clamped when being inserted into the reception portion or to latch with the reception portion.

14. The driver device according to claim 13, wherein the insertion portion has latching projections, which extend parallel to each other and have a predetermined distance to each other, and wherein the reception portion of the mounting portion, at least in an area nearest the driver member, has a slot-shaped opening with an opening width which is slightly smaller than a distance of exterior ends of the latching projections to each other, the slot-shaped opening extending parallel to a longitudinal extension of a latching edge of one of the latching projections.

15. The driver device according to claims 11, wherein the spring element is configured as a hinge spring having one end supported at a side of the guided member facing the panel to be moved or is stationarily mounted thereto and having another end supported at a side of the panel to be moved facing the guided member.

16. The driver device according to claim 15, wherein legs of the hinge spring include an acute angle.

17. The driver device according to claim 11, wherein the spring element is configured as a hinge spring, a free end of the hinge spring being freely rotatably received in an opening configured in a seating portion of the driver member, one axis of rotation of one end of the hinge spring extending transverse to a direction of the guided member towards the panel to be moved, another end of the hinge spring being received in an opening configured in the seating portion and freely displaceable supported along a tensioning distance of the other end of the hinge spring.

18. The driver device according to claim 11, wherein the spring element is configured as a helical spring having with one end supported at a side of the guided member facing the panel to be moved and another end supported at a side of the panel to be moved facing the driver member, or at a connecting element coupled to the driver member.

19. The driver device according to claims 11, wherein the spring element and the driver member are integrally configured, the spring element forming a spring portion and the driver member forming a driver portion of the driver device.

20. The driver device according to claim 19, wherein the driver portion has a reception, which is configured to reach, in an inserted condition, a latching engagement or clamping engagement with a complementary configured counter-piece in an area of the reception, and wherein the counter-piece is configured at or disposed at the driver member.

21. The driver device according to claim 13, wherein the driver member has an insertion portion and the panel to be moved has a mounting portion with a reception, the insertion portion being formed such as to be clamped when being inserted into the reception portion or to latch with the reception.

22. The driver device according to claim 12, wherein the spring element is configured as a helical spring having with one end supported at a side of the guided member facing the panel to be moved and another end supported at a side of the panel to be moved facing the driver member, or at a connecting element coupled to the driver member.

23. The driver device according to claim 13, wherein the spring element is configured as a helical spring having with one end supported at a side of the guided member facing the panel to be moved and another end supported at a side of the panel to be moved facing the driver member, or at a connecting element coupled to the driver member.

24. The driver device according to claims 12, wherein the spring element and the driver member are integrally configured, the spring element forming a spring portion and the driver member forming a driver portion of the driver device.

25. The driver device according to claims 13, wherein the spring element and the driver member are integrally configured, the spring element forming a spring portion and the driver member forming a driver portion of the driver device.
